(19) United States
(12) Patent Application Publication
(10) Pub. No.: US 2014/0028449 A1
(43) Pub. Date: Jan. 30, 2014

(54) SYSTEM AND METHOD FOR USING PERSONAL ELECTRONIC DEVICE TO WIRELESSLY LINK REMOTE DIAGNOSTIC SITE TO A HOME APPLIANCE FOR TROUBLESHOOTING

(71) Applicant: Myine Electronics, Inc., Ferndale, MI (US)

(72) Inventors: Jacob R. SIGAL, Ferndale, MI (US); Massimo BALDINI, Beverly Hills, MI (US)

(73) Assignee: Myine Electronics, Inc., Ferndale, MI (US)

(21) Appl. No.: 13/951,995

(22) Filed: Jul. 26, 2013

Related U.S. Application Data
(60) Provisional application No. 61/676,523, filed on Jul. 27, 2012.

(51) Int. Cl. G08C 17/02

(52) U.S. Cl. CPC G08C 17/02
USPC 340/12.5

(57) ABSTRACT

In one aspect the present disclosure relates to a method for remotely communicating with a product, where the product has a processor. The method may comprise using a program downloaded from a website onto a user's personal electronic device (PED) to establish first and second wireless communications links. The first wireless communications link may be between the PED and the processor of the product while the PED is in a vicinity of the product. The second wireless communications link may be via a wide area network between the PED and a remotely located management system. The management system may be used to communicate with a service facility responsible for at least one of repair or maintenance of the product to enable at least one of remote diagnosing of problems with the PED or remote updating of the PED.

### CROSS-REFERENCE TO RELATED APPLICATIONS

This application claims the benefit of U.S. Provisional Application No. 61/676,523, filed on Jul. 27, 2012. The entire disclosure of the above application is incorporated herein by reference.

### FIELD

The present disclosure relates to diagnostic systems, and more particularly to a system and method that makes use of an individual's personal electronic device, such as a smartphone or tablet, to wirelessly connect a remote diagnostic site to an appliance, to enable the remote site to conduct troubleshooting and diagnostics, or firmware updating, or status checking on the appliance.

### BACKGROUND

The statements in this section merely provide background information related to the present disclosure and may not constitute prior art.

Present day household appliances such as refrigerators, microwave ovens, washers, dryers, etc., are increasingly being equipped with an electronic control module or electronic processing system. The control module or processing system is often a microprocessor based system that controls and interfaces with various other components of the appliance, such as a motor of the appliance, or a timer of the appliance, or an interface panel of the appliance, or a heating element of the appliance, or a compressor of the appliance, etc. More and more present day appliances have sufficient intelligence, in large part because of the increasingly sophisticated central control or processing systems that they employ, that they are able to generate error codes and/or are able to be controlled in a manner so that some diagnostic procedures can be performed on them. However, even when such appliances malfunction and are able to display an error code, frequently the error code may appear cryptic to the user. In other words, the error code may still not convey enough information to the user about the nature of the apparent malfunction to help the user decide if an in-home service call is required. As such, the user is often placed in the position of requiring an in-home service call by a service representative so that other more extensive diagnostics can be performed on the malfunctioning appliance.

It is also expected that with the growing electronic sophistication of present day home appliances, such appliances will increasingly have short range wireless connectivity capabilities. By that it is meant that more and more home appliances are expected to include at least one of a BLUETOOTH® wireless communication protocol chipset, and/or capability, and/or Near Field Communication capability, for enabling an external electronic device to make a short range wireless connection with the control module or processing system of the appliance.

The foregoing developments relating to the increasing sophistication of various household appliance, the increasing ability to wirelessly connect and interface to the central control module of a household appliance, and the ubiquity of smartphone users, opens the possibility for more sophisticated interrogation, diagnostics, troubleshooting and firmware updating of household appliances by using other remotely located devices or systems that can wirelessly connect to the appliance and communicate with the appliance's electronics. This raises the possibility of more cost effective and efficient troubleshooting of various types of home appliances, and the possibility of conducting such troubleshooting/diagnostic/updating activities without having a service technician make a trip to the user's home.

### BRIEF DESCRIPTION OF THE DRAWINGS

The drawings described herein are for illustration purposes only and are not intended to limit the scope of the present disclosure in any way.

FIG. 1 is a high level diagram showing one example of a system for using a smartphone to wirelessly link a remote diagnostic facility with a household appliance for the purpose of interrogating a central control module of the appliance and performing diagnostics on the appliance; and

FIG. 2 is a flowchart showing one example of a sequence of operations that may be performed in wirelessly linking a remote diagnostic facility with a household appliance via a user's smartphone.

### DETAILED DESCRIPTION

The following description is merely exemplary in nature and is not intended to limit the present disclosure, application, or uses. It should be understood that throughout the drawings, corresponding reference numerals indicate like or corresponding parts features.

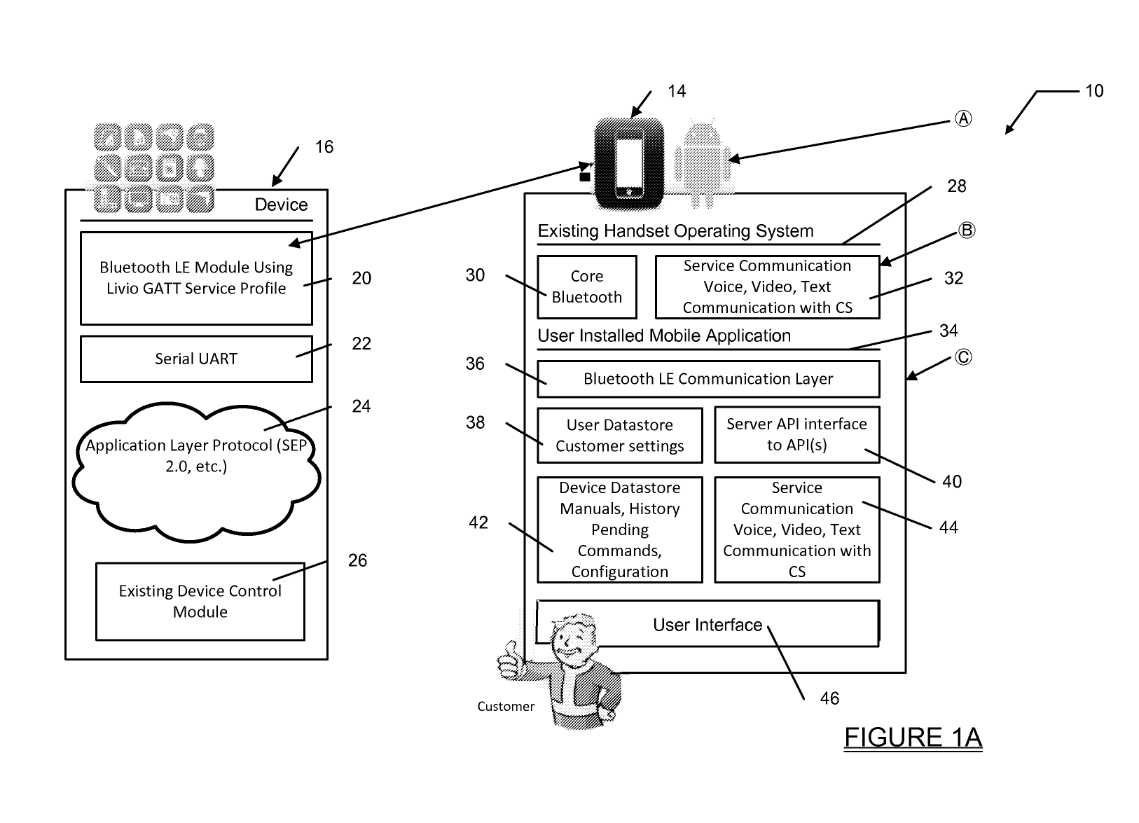

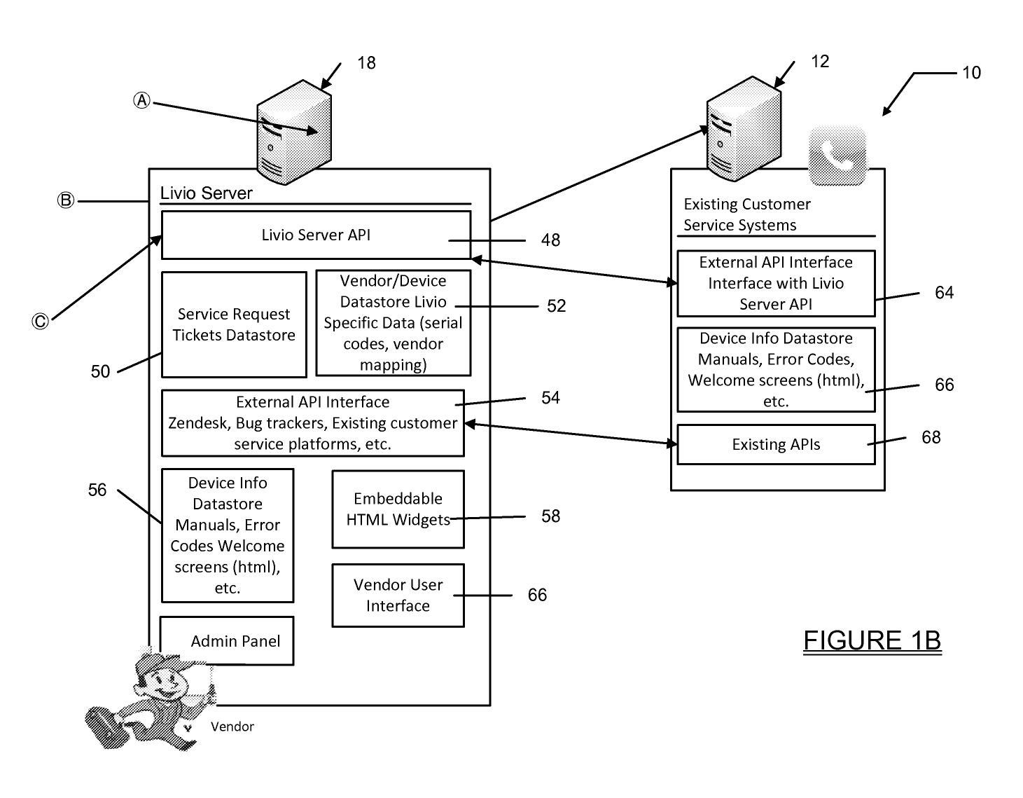

Referring to FIG. 1, a high level diagram of a system 10 is shown for wirelessly linking a remote site, in this example a remotely located customer service system 12, via a user's smartphone 14, with a household appliance 16. A service management system 18 may also be employed for communicating, via the smartphone 14, with the appliance 16. It will be appreciated immediately that while the use of smartphone 14 is being described, that a wireless connection could also be established using other types of personal electronic devices, possibly a computing tablet, a computer such as a laptop, etc. Essentially any electronic user device that is able to establish a short range wireless link with the appliance 16, as well as connect by either a cellular link or a WiFi link with the service management system 18, could potentially be used to implement the system 10. As such, the system 10 is not limited to use with only smartphones.

In FIG. 1 the household appliance 16 may take any form including, without limitation, an electric range, a microwave oven, a refrigerator, a dishwasher, a freezer, an air conditioner (window or central), a standalone ice maker, a washer, a dryer, a television, a home stereo, garage door opener, or virtually any other large or small appliance that may be used at one's home. However, it is anticipated that large appliances such as refrigerators, washers, dryers, microwave ovens, electric ranges, etc., which cannot be easily shipped back to a manufacturer for service, and which thus typically necessitate a service call by a service technician to the user's home, will be the types of appliances that may benefit the most from the system 10. And it will be appreciated that the methodology of the present disclosure will be equally applicable to non-household and/or hand held appliances such as power tools (electrically powered drills, saws, air compressors, etc.) and other small electrically powered devices (e.g., hair dryers, curling irons, vacuum cleaners, sewing machines, mobile telephone units, cameras, camcorders, etc.).

The system 10 may also be employed, for example, in connection with automotive diagnostics. If a user has trouble with his/her vehicle, the system 10 could just as easily be employed to wirelessly link a remote diagnostic site, such as a service department of a vehicle dealership, with an on-board computer of the vehicle. Thus, if the user has vehicle trouble and is not in the vicinity of a vehicle dealership, the user would still be able to wirelessly link his/her vehicle's on-board computer with a service facility, provided of course that a cellular of WiFi link can be established with the remote facility using the user's smartphone. Similarly, the system 10 could be used with other types of vehicles, for example large earth moving or excavating equipment that experience a malfunction, or heavy trucks used for shipping goods, manufacturing and/or assembly or robotic equipment mounted in factories, etc. Virtually any type of device that makes use of an on-board microprocessor for its control or performance monitoring could potentially be wirelessly accessed using the system 10.

With continued reference to FIG. 1, the appliance 16 may include a plurality of components such as a BLUETOOTH® protocol LE (low energy) module 20, a serial UART (universal asynchronous receiver/transmitter) 22, an application layer protocol 24, and an internal control module 26. In lieu of a BLUETOOTH® protocol LE Module 20, other wireless communication protocols could be implemented such as, without limitation, the ZigBee short range wireless communication protocol, the Near Field Communication (NFC) protocol, etc.

The smartphone 14 may include a core operating system 28 having a BLUETOOTH® protocol communication subsystem 30 and a service communication subsystem 32. The service communication subsystem 32 may be tailored to enable one or more of voice, video or text communications between the smartphone 14 and a technician at the customer service system 12. The smartphone 14 may also include a mobile application 34 that may be obtained (e.g., by downloading) from a suitable website of the manufacturer of the appliance 16, and which may be used to facilitate diagnostics and communications with the appliance 16. The mobile application 34 may include a BLUETOOTH protocol LE communications layer 36 for facilitating a short range wireless connection (typically with 10 feet or so) with the appliance 16. A user datastore 38 may be used to store user (e.g., customer) settings. User settings may include the user's preference on how a technician should contact him/her. So if the user wanted to be reached by video chat, the user could put his/her video chat contact information in the user settings. If the user wanted to be contacted via a different telephone number, he/she would include this information in the user datastore 38 as well. A server API (Application Programming Interface) 40 interfaces the smartphone 14 to the management system 18. The server API 40 represents one method that the smartphone 14 may use to forward data on to the service management system 18. Data may include service requests, tickets, data transferred from the device, etc. A device datastore 42 may be used to store manuals for the appliance 16, service history information, configuration information, available commands used to control the appliance 16, or any other information that may be pertinent to troubleshooting/updating the appliance 16 and/or conducting diagnostics on the appliance. A service communications subsystem 44 may be included for facilitating any one or more of voice, video and/or text communications between the smartphone 14 and the customer service system 12. A user interface 46 may be provided that enables the user to input commands or take some instructed action when the smartphone application 34 is running and performing troubleshooting or diagnostics.

With further reference to FIG. 1, the service management system 18 may include one or more servers having an API 48 that interfaces with the API 40 of the smartphone application 34. The API 48 operates to assist with sending and receiving data stored on the service management system 18. It may map 1:1 with the API 40 of the smartphone application 34. Thus, the API 40 may help send a ticket to the service management system 18, and an API call on the service management system 18 could operate to retrieve device data, as one example sequence of operation. It will be appreciated that the service management system 18 may be operated by a third party service organization, but may be constructed or branded to appear to the user as if it is part of the appliance manufacturer company. The service management system 18 may include a Service Request Tickets datastore 50 which may be used to store service tickets relating to the appliance 16 (i.e., relating to current service being performed or previously performed service on the appliance). A vendor/device datastore 52 may be provided for storing data that will be helpful in looking up device faults to improve customer service, analyzing a history of device faults to find patterns of failure, and looking up a history of device faults compared to a history of customer service tickets to improve both the device and the service process. An external API interface 54 may be included for implementing an existing customer service platform or on-demand customer support portal. A device information datastore 56 may be included for storing manuals, Welcome screens, error codes, etc. for the appliance 16. Embeddable HTML widgets 58, an administrative panel 60 and a vendor user interface 62 may also be provided.

Referring further to FIG. 1, the customer service system 12 may also include an external API interface 64 for facilitating communications with the API 48 of the service management system 18. A device information datastore 66 may be included for storing various information including, but not limited to, product operating and/or service manuals, lists of error codes, and Welcome screens (HTML) and other product related information. Existing APIs 68 may also be located on the customer service system 12. The customer service system 12 may be used to provide direct support (i.e., a direct link through the system 18) from the manufacturer's service department. It will be appreciated that the customer service system 12 is not essential to the system 10. It has been illustrated to help show how a typical, existing customer service system operated by a manufacturer may be integrated into the system 10 to even further enhance the capabilities of the system 10. The direct support provided from the customer service system 12 would typically be initiated after the customer service technician receives prior information about a device fault, and after a customer's request for help to the service management system 18. In the end, a customer service technician associated with the service management system 18 will typically directly contact the customer. The value added by including the customer service system 12 is the possible additional information that the technician may obtain from the system 12 so that the technician can initially answer the customer's service call with even more valuable diagnostic/troubleshooting/updating information that will potentially save both the customer and the technician time. But it will be appreciated that the system 10 may be configured with just the service management system 18 (i.e., no other link to any form of manufacturer's customer service system).

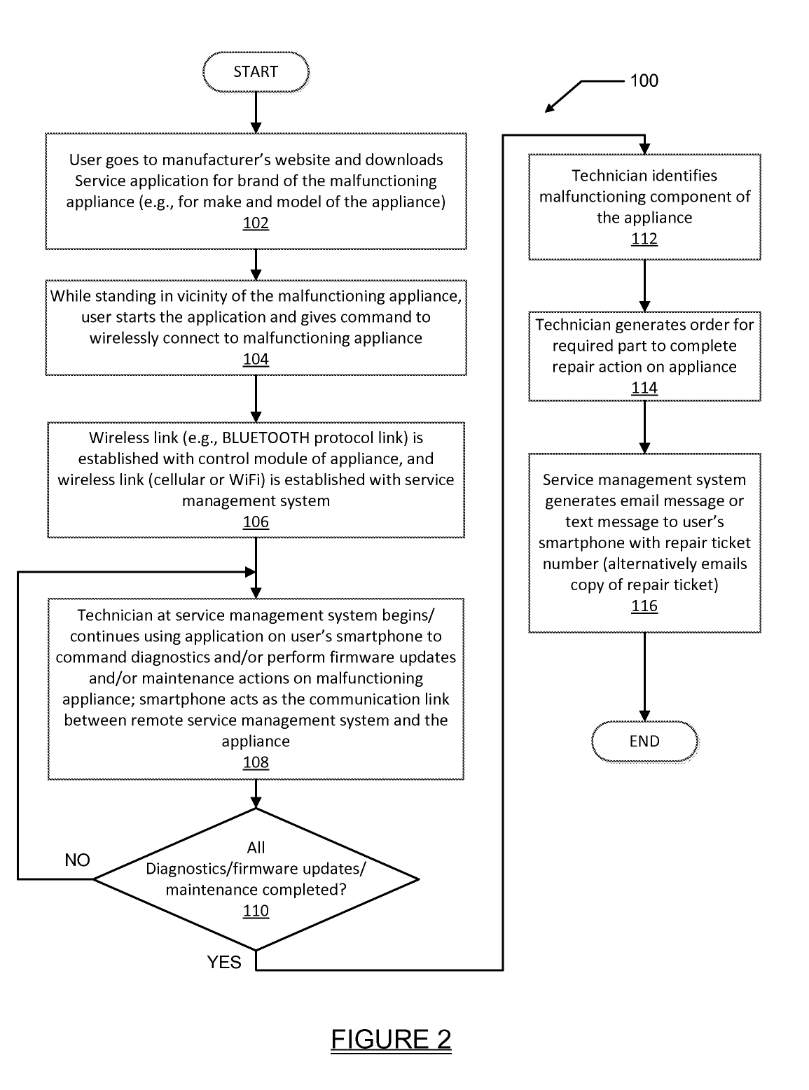

Referring now to FIG. 2, a flowchart 100 is shown of one example of a sequence of operations that may be performed in implementing and using the system 10. At operation 102 the user first goes to the manufacturer's website and downloads a service application for the brand of appliance he needs to have troubleshooted. There may be specific applications included for different makes and/or models of appliances. For example, the manufacturer may have two or more different brands of appliances that it manufactures, and each brand may have different types of appliances. But in any event the user downloads the application that he/she needs to work with his/her specific appliance. Once the application is downloaded and installed on the user's smartphone 14, while standing in close vicinity to the affected appliance 16, the user may start the application and give a command to cause the smartphone 14 to use the application to wirelessly connect to the malfunctioning appliance 16, as indicated at operation 104.

At operation 106 a wireless communications link will be established between the smartphone 14 and the appliance 16, and a link (either cellular, e.g., 3 G or 4 G, or a WiFi link) will also be established between the smartphone 14 and the remotely located service management system 18. Alternatively, a direct link could be established with the customer service system 12 by using the service management system 18, but in this example it will be assumed that resources at the service management system 18 are being used for the service call.

At operation 108 a technician at the service management system 18 takes control of the service call session and continues using the application that has been downloaded onto the user's smartphone 14 to command diagnostics and/or to load firmware updates onto one or more internal electronic components of the malfunctioning appliance 16. Basically the smartphone 14 acts as the communication intermediary (or intermediate link) between the service management system 18 and the malfunctioning appliance 16.

At operation 110, the service technician makes a determination if all appropriate diagnostics and/or firmware updates have been run or completed. If not, the service technician continues to run additional diagnostic tests and/or continues to load firmware updates onto the appliance 16, as indicated at operation 108. However, if at operation 110 the service technician has completed running all appropriate diagnostics and/or completed loading all applicable firmware updates, then at operation 112 the technician identifies the malfunctioning component of the appliance 112. Of course, this action presumes that the malfunction will be identifiable through the diagnostics available to the service technician, but if the malfunctioning component(s) of the appliance 16 cannot be identified, then a formal on-site service call may be scheduled with the user. But assuming that the malfunctioning component of the appliance 16 is identified, then at operation 114 the technician may immediately generate an order for the required replacement part to complete the repair action on the appliance. The service management system 18 may then be used to generate an email message or a text message that is sent to the user's smartphone 14, and which includes a repair ticket number and/or other information concerning the service action which has just taken place.

From the foregoing it will be appreciated that the system 10 can significantly expedite the troubleshooting and repair of a wide variety of appliances. It is a significant advantage that the diagnostic session (or firmware updating session) can be implemented virtually immediately after the user downloads and starts the mobile service application from the manufacturer's website. It will also be appreciated that the manufacturer may include mobile service applications for both smartphones that use the Android™ operating system as well as iPhones manufactured by Apple Computing, Inc. It is expected that in some instances the technician handling the service call may be able to remotely perform various operations on the malfunctioning appliance 16, possibly such as performing a reset action that removes the error code and restores the appliance 16 to it normal operating condition, so as to completely eliminate the need for an on-site service call. In other instances the service technician may provide additional instructions to the user to engage certain controls of the appliance in a manner that affects a reset action or otherwise eliminates the error condition, and thus eliminates the need for an on-site service call. If the cause of the malfunction is discovered by the service technician during the remote diagnostic process, the required part can be ordered immediately, thus possibly saving the user several days of down time for the affected appliance.

In still other embodiments it is possible for the user to use the camera that is typically included on all smartphones to supply live video or pictures of portions of the malfunctioning appliance back to the service technician. This could further help the technician to identify issues (e.g., burnt wires, discolored component, etc.) that would give the technician valuable information on which component(s) will need to be replaced. While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

1. A method for remotely communicating with a product, the product having a processor, the method comprising:
using a program downloaded from a website onto a user's smartphone personal electronic device (PED) to establish:
a first wireless communications link between the PED and the processor of the product, while the PED is in a vicinity of the product; and
a second wireless communications link, via a wide area network, between the PED and a remotely located management system; and
using the management system to communicate with a service facility responsible for at least one of repair or maintenance of the product at least one of remote diagnosing of problems with the PED or remote updating of the PED.

2. The method of claim 1; wherein establishing the second wireless communications link comprises using the second wireless communications link to enable at least one of commands or information to be transmitted from the management system to the processor of the product via the first and second wireless communications links to at least one of:
diagnose a malfunction affecting the product; or
provide firmware updates to the product.

3. The method of claim 1, wherein the operation of using a program downloaded from a website onto a user's PED comprises using a program that provides a user datastore which provides a storage for user selected settings and preferences for conducting communications with the service facility.

4. The method of claim 1 wherein the operation of using a program downloaded from a website onto a user's smartphone to establish a second wireless communications link comprises using a server application programming interface (API) to interface the user's smartphone to the management system; and
further comprising using an API with the management system that interfaces with the server API and which assists with storing and sending data stored on the service management system.

5. The method of claim 1, further comprising using an API interface associated with the service facility to facilitate communications with the management system.

6. The method of claim 5, further comprising using a device information datastore associated with the service facility for storing information relating to at least one of servicing or diagnosing errors with the product.

7. A method for remotely communicating with a product, the product having a processor, the method comprising:
using a program downloaded from a website onto a user's smartphone to establish:
a first wireless communications link between the smartphone and the processor of the product, while the smartphone is in a vicinity of the product; and
a second wireless communications link, via a wide area network, between the smartphone and a management system, wherein the management system is in communication with a service facility responsible for at least one of repair or maintenance of the product;
using the second wireless communications link to enable at least one of commands or information to be transmitted from the management system to the processor of the product via the first and second wireless communications links to at least one of:
diagnose a malfunction affecting the product; or
provide firmware updates to the product.

8. The method of claim 7, wherein the operation of using a program downloaded from a website onto a user's smartphone to establish a second wireless communications link comprises using the Internet.

9. The method of claim 7, wherein the operation of using a program downloaded from a website onto a user's smartphone comprises using a program that provides a user datastore which provides a storage for user selected settings and preferences for conducting communications with the service facility.

10. The method of claim 9, wherein the user selected settings and preferences includes at least one of:
a selection by the user that the user wishes to be reached by video chat; and
a selection by the user that the user wishes to be contacted at a specific telephone number;

11. The method of claim 7, wherein the operation of using a program downloaded from a website onto a user's smartphone to establish a second wireless communications link comprises using a server application programming interface (API) to interface the user's smartphone to the management system.

12. The method of claim 11, wherein the server API is used to forward data to the service management system.

13. The method of claim 12, further comprising using an API with the management system that interfaces with the server API and which assists with storing and sending data stored on the service management system.

14. The method of claim 11, wherein the data comprises forwarded by the server API comprises at one of: service requests and tickets.

15. The method of claim 12, further comprising providing the server API with a device datastore for storing at least one of:
a manual for the product;
service history information pertaining to the product;
configuration information pertaining to the product; and
available commands used to control the product.

16. The method of claim 15, further comprising using a vendor/device datastore of the management system for storing data useful in looking up a history of faults of the product.

17. The method of claim 7, further comprising using an API interface associated with the service facility to facilitate communications with the management system.

18. The method of claim 17, further comprising using a device information datastore associated with the service facility for storing information relating to at least one of servicing or diagnosing errors with the product.

19. A method for remotely communicating with a product, the product having a processor, the method comprising:
using a program downloaded from a website onto a user's smartphone, the program including a server application programming interface (API) for facilitating communications, and using the program to establish:
a first wireless communications link between the smartphone and the processor of the product, while the smartphone is in a vicinity of the product; and
a second wireless communications link, via a wide area network, between the smartphone and a remotely located management system, wherein the remotely located management system includes an API for communicating with the server API of the program on the user's smartphone;
using the management system is in communication with a service facility responsible for at least one of repair or maintenance of the product;
using the second wireless communications link to enable at least one of commands or information to be transmitted from the management system to the processor of the product via the first and second wireless communications links to at least one of:
diagnose a malfunction affecting the product; or
provide firmware updates to the product;
using an external API interface associated with the service facility to facilitate communications with the API of the management system; and
using a device information data store associated with the service facility to store information relating to at least one of service information, error codes and welcome screens for the product for enabling a service representative in diagnosing a problem with the product while communicating with the product via the first and second communications links.
